(19) United States
(12) Patent Application Publication
(10) Pub. No.: US 2026/0297934 A1
(43) Pub. Date: Oct. 1, 2026

(54) MODULAR SYSTEM FOR PRODUCING AND SEALING A LINE FEEDTHROUGH

(71) Applicant: Hilti Aktiengesellschaft, Schaan (LI)

(72) Inventor: Christian Förg, Buchloe (DE)

(73) Assignee: Hilti Aktiengesellschaft, Schaan (LI)

(21) Appl. No.: 18/996,369

(22) PCT Filed: Jul. 11, 2023
(86) PCT No.: PCT/EP2023/069149

§ 371 Date: Jan. 17, 2025

(30) Foreign Application Priority Data
Aug. 1, 2022 (EP) 22188045.3

(51) Int. Cl. E04B 1/94

(52) U.S. Cl. CPC E04B 1/946; E04B 1/947

(57) ABSTRACT

A modular system for producing and sealing a line feedthrough in a wall including a plurality of cladding tubes and a plurality of mounting plates. Also disclosed is a method for producing and sealing a line feedthrough using the modular system, and a line feedthrough in a wall produced by the method.

### FIELD OF THE INVENTION

The invention relates to a modular system and to an associated method for producing and sealing a line feedthrough, for example for cables or pipes which are to be guided through a wall. The wall can be, for example, a side wall, ceiling or a floor of a building. It can be, in particular, a fire-resistant sealing of the line feedthrough, especially against flue gases and/or against heat transfer.

### BACKGROUND OF THE INVENTION

Various pouring devices and fire-resistant cable boxes for the sealing, i.e., fire-resistant sealing, of pipe or cable feedthroughs through a building wall are known from the prior art. They generally comprise a bushing sleeve which is set in concrete in a wall section to be produced or in a wall breakthrough (pouring devices) or can be installed in another way in order to close the wall breakthrough and thereby form a passage channel for guiding lines such as cables or pipes through it. The passage channel must generally be sealed to a sufficient extent against smoke, heat, gases and other media which in case of fire can develop in the building. This is intended to largely prevent propagation of the fire and harmful fire effluents such as smoke and gases from an affected room through the line feedthrough and into other rooms.

So-called sleeves are frequently used in the region of the cable feedthroughs. Very simple sleeves consist of a metal cladding tube, which serves to form a cut-out in the sense of a through-opening when the wall is concreted, and of a sealing compound for sealing the lines which are guided through this cut-out. More powerful sleeve solutions are usually made of a metal frame with fire protection and sealing function. These sleeves are normally inserted, after completion of the raw concrete wall or raw concrete ceiling, into a through-opening provided therein and, for example, subsequently fastened and sealed by means of a mounting frame.

However, the above-mentioned systems are usually not completely smoke-tight when used for guiding pipe bundles or cable bundles. This is because, as a rule, the spandrels and interspaces forming on and between the individual lines of a bundle cannot be closed completely tightly. In order to solve this problem, sleeves with an internal structure divided in cross section are also known in particular in the region of the building inlet, in order to allow a separation solution, i.e., individual cable sealing. These systems are optimized for tightness, with separation generally taking place only in the region of the outer sealing plane. In the case of additional fire protection requirements, suitable additional fire tightness and thermal insulation measures can also be ensured in a known manner.

The problem with these and other known systems is usually that a sleeve or box that is dimensioned relatively large in relation to the diameter of a single line (such as a cable or tube) is used. This sleeve/box is usually designed universally and configured to guide as many cables/pipes as possible, but must also function in a sealing manner in the case of so-called zero occupancy. Therefore, fire protection measures used therein are designed to cover the maximum range of application areas and are thus oversized in most cases. Thus, the uniform largest sleeve is also to be used in the separation solution mentioned above, and is designed for example for a dozen different cables with varying diameters, even if only a few cables are to be laid.

Further systems for fire-resistant production and/or sealing of line feedthroughs are known, for example, from US 2007283644, CN 201536237, US 2019120409, US 2016123002, US 2014020315 and DE 10331743.

It is an object of the present invention to provide a system and a corresponding method for producing and sealing a line feedthrough which can provide an optimum with regard to at least some and ideally all of the following aspects: simple sealing; good tightness; economic viability in production, in the case of material use and for the user; flexible adaptability to individual needs of the user; and less space requirement.

### SUMMARY OF THE INVENTION

This object is achieved by a modular system according to claim 1 for producing and sealing a line feedthrough and by an associated method and a line feedthrough produced thereby according to the additional independent claims. Further embodiments are specified in the dependent claims. All features and effects described herein for the modular system apply accordingly to the method and the line feedthrough, and vice versa.

The line feedthrough can relate in particular to electrical cables, but also pipes or other types of lines which are to be guided through a fire compartment. The line feedthrough can be produced in particular in a (concrete) wall to be erected or a wall breakthrough to be closed. The wall can be, for example, a side wall, ceiling or a floor of a building. It can be, in particular, a fire-resistant sealing of the line feedthrough, especially against flue gases and/or against heat transfer.

According to a first aspect, a modular system for producing and sealing a line feedthrough is provided. With this modular system, the problems mentioned at the beginning can be solved and the above-mentioned objects can be achieved. In particular, the user can therewith adapt the line feedthrough individually to its needs, for example with regard to the number and the diameters of the lines to be passed through and sealed, with a consistently reliable sealing function and simplicity of production and sealing of the line feedthrough.

For this purpose, the modular system comprises the following two types of components, which are ideally present in different sizes:

On the one hand, the modular system comprises a plurality of cladding tubes, i.e., elongate cylindrical hollow bodies, each cladding tube forming an axial passage channel in its longitudinal direction for passing through a single line. In its initial state, the passage channel is closed by a sealing element on one or both end faces of the cladding tube before the line is laid. The sealing element has a pierceable sealing membrane which is designed to be perforated by a single line (cable or pipe) when inserted into the passage channel and to enclose the perforating line again from all sides, without further intervention. The sealing membrane can be produced from any material which is suitable for this functionality, in particular elastically stretchable material, such as, for example, soft PVC (polyvinyl chloride), rubber etc., with a thickness selected depending on the respective diameters of the cladding tube and the perforating line. The cladding tubes can basically have any cross-sectional shapes, in particular circular, oval, or polygonal, in particular also rectangular. In the modular system, the cladding tubes can be provided in particular with a plurality of different cladding tube diameters and/or cross-sectional shapes in order to be suitably selected for lines of different line diameters and/or cross-sectional shapes. The correct choice of a cladding tube suitable in each case, which ensures the function described above, can be ensured, for example, by means of supplied tables or labels on the cladding tubes which indicate suitable line diameters and/or materials, in particular also for inexperienced users.

On the other hand, the modular system comprises a plurality of mounting plates (also referred to as base plates), which are in particular similar or identical in pairs to one another and/or can be connected to one another edge to edge to form an enlarged surface. Each mounting plate has one or more cut-outs. Each cut-out is designed to receive and at least temporarily fix one of the cladding tubes from the modular system with an outer diameter corresponding to the cut-out and a corresponding cross-sectional shape. The cut-outs are expediently designed to position and fix the cladding tubes with their axis substantially perpendicular to a mounting plate surface or mounting plate plane. The cut-outs can, in particular, be designed as through-holes; however, in reusable mounting plates which are to be removed after production of the line feedthrough, they can alternatively also be designed as blind holes, etc.

If a mounting plate has a plurality of cut-outs, they are arranged and formed in relation to radial outer dimensions of the associated cladding tubes such that a radial distance and thus an interspace remains between the cladding tubes which are fixed to directly adjacent cut-outs, which interspace can be filled in particular with a flowable wall construction material (such as concrete, etc.) during wall construction or closing of a wall breakthrough.

The modular system can, in particular, comprise a plurality of mounting plates which can be fastened to one another in each case edge to edge to form a composite mounting plate and which have cut-outs that are configured identically or differently from mounting plate to mounting plate in the same or different number and/or arrangement in each case. Here too, the cut-outs in the individual mounting plates are arranged and formed in relation to the radial outer dimensions of the associated cladding tubes such that a radial distance and thus an interspace for filling with a flowable wall construction material (such as concrete, etc.) remains between the cladding tubes which are fixed to directly adjacent cut-outs in each two mounting plates connected to one another. This can contribute, for example, to ensuring sufficient cooling and/or an external sealing of the cladding tubes.

The main function of the mounting plates is to position the cladding tubes before and during construction of the wall or during closing of a wall breakthrough in which the line feedthrough is to be produced. For this purpose, the mounting plate with cladding tubes fixed thereto can be fastened, for example, to formwork which is used for pouring and hardening a flowable wall construction material (in particular concrete) for the respective wall section. After the wall has hardened, the mounting plates can be removed from the finished wall section and reused for example together with the formwork. However, this is not mandatory. It is therefore also possible for the mounting plates to remain permanently in the wall or concrete ceiling. In this case, the mounting plates can be manufactured as easily as possible and with as little material as possible, for example from a recycling material. Moreover, the mounting plates can be made, for example, of plastic or metal or any other material suitable for the functionality described herein.

In addition to its flexible adaptability to the user's individual size and quantity requirements due to the modularity, one feature of the present modular system is also its separation principle and the particularly powerful structural concept of its realization. On the one hand, a separate cladding tube with at least one sealing membrane to be perforated by a line is provided for each line to be laid, which sealing membrane can therefore seal the individual line from all sides without gaps. On the other hand, after the construction (of all required cladding tubes on the mounting plates fixing them) has been embedded in concrete (or any other wall construction material), each cladding tube is surrounded by the concrete (or other wall construction material). As a result, each line can be cooled significantly better via its own suitably dimensioned cladding tube, for example in case of a fire or some other heat transfer event, than, for example, an entire cable bundle in a single sleeve, in which, for individual cables of the bundle, it is possible to achieve significantly less contact with the surrounding cool concrete (or other wall construction material). Further embodiments, associated effects and advantages of the proposed modular system are described further below.

In practice, the user will typically already have an electrical plan before the erection of individual walls in the building, which plan will show which cables and other lines are to be guided, or can be guided, through which walls. Based on this plan, the user of the modular system, for example an electrician, can prepare the cable routes and conductor tracks accordingly during the installation work performed prior to wall construction by selecting the appropriate empty cladding tubes from the modular system and positioning them as described herein using the mounting plates suitable for this purpose, and encasing or embedding them in concrete in the required wall section. The user can individually design the configuration of the line feedthrough with regard to the number, size and mutual arrangement of individual passage channels/cladding tubes for individual lines by means of the modular system, and can flexibly adapt it to the user's specific desires and requirements.

According to one embodiment, at least some of the mounting plates of the modular system have at least one connecting element for fastening to one another. The assembled mounting plates can thus be fixed next to one another in a suitable arrangement, in particular to ensure predetermined suitable distances for the cladding tubes fastened thereto and/or to obtain a stable and/or compact assembly.

In particular, each of these mounting plates (and ideally each mounting plate of the modular system) can have at least two connecting elements which are designed to be complementary to one another and are designed and arranged in the same way in each mounting plate, so that connecting elements of two mounting plates are to be brought into positive engagement with one another for fastening to one another. In this way, for example, a modularity of the modular system can be achieved in a particularly simple manner, in which, for example, all mounting plates can be connected to one another in any combination to form a composite mounting plate with an enlarged surface and number of recesses. This type of connecting element can also be particularly simple with regard to the production of the modular system and/or handling during assembly.

As already mentioned, at least some of the cut-outs can be designed as through-openings in the mounting plates. In this embodiment, the associated cladding tubes can be inserted at least partially into the respective cut-out for fixing to the mounting plate. In particular, the passage channel of the respective cladding tube can thereby remain unconcealed by the mounting plate, so that the mounting plate can remain in the wall with the line feedthrough (disposable mounting plate) for example even after completion of the wall section.

According to one embodiment, at least some of the cladding tubes have a circumferential shoulder on the outside at least at one of their two ends, which shoulder can be formed, for example, by a depression extending from the end face of the cladding tube to the shoulder, or by a radial projection. The shoulder is arranged at a predetermined axial shoulder distance from the end face of the cladding tube, and the associated cut-outs in the mounting plates have an inner diameter which substantially corresponds exactly to an outer diameter of such an associated cladding tube in its axial end section beyond the shoulder. In other words, in this embodiment, the cladding tube can be inserted into the cut-out up to the stop on its shoulder, as a result of which, in addition to a considerable simplification of the assembly process, the robustness and/or the precision of positioning the cladding tubes on the mounting plates can also be increased.

According to one embodiment, at least some of the cladding tubes can have at least one intumescent element on the inside and/or on the outside, which can be designed to comply with predetermined fire safety measures. For this purpose, the intumescent element can be designed, for example, as a circumferential strip made of or comprising an intumescent material, i.e., a material that foams up under the effect of heat and additionally closes the passage channel on the inside or on the outside. The outer intumescent element can be arranged in particular at a predetermined axial undercut distance from the respective end face or, optionally, from the above-mentioned shoulder of the cladding tube, in order to form an undercut in the later introduced wall construction material (concrete, etc.).

According to one embodiment, at least in the case of some of the cladding tubes, the respective sealing membrane in its non-perforated state can be arranged at a predetermined axial membrane offset from the associated end face in the cladding tube. With such a recessed membrane arrangement in the cladding tube, it is possible to reliably avoid, for example, unintentional membrane damage, for example when a liquid concrete layer (or other wall construction material) is stripped off with a power trowel or scraping tool during wall construction.

In particular, at least one of the mounting plates can have one or more fastening elements for at least temporary fastening of the mounting plate to wall construction formwork. This also makes it easier to simplify the process described in more detail below of constructing the wall and the line feedthrough formed therein and/or to increase the robustness of the assembly. In particular, such a fastening element can be designed as a through-hole for receiving a connecting body such as a nail, a screw or a bolt.

According to one embodiment, at least some of the cladding tubes can have, at least at one of their two ends, a locating element extending axially beyond the end face of the cladding tube by a predetermined length, in particular in the form of brush-like whiskers attached to the cladding tube. Alternatively or additionally, at least one of the mounting plates can also have in an edge region of its surface at least one locating element projecting by a predetermined length from the mounting plate surface, in particular in the form of brush-like whiskers attached to the mounting plate. Such locating elements can make it easier to find the line feedthrough after the assembly has been concreted in a wall.

According to one embodiment, the cladding tubes, on the one hand, and the associated cut-outs in the mounting plates, on the other hand, are designed such that the respective cladding tube in its state fixed to the mounting plate does not protrude axially beyond a mounting plate surface facing away from the cladding tube. In particular, this mounting plate surface can even project by a predetermined axial protection offset beyond the end face of the cladding tube fixed thereto. With such a recessed arrangement of the cladding tubes in the mounting plates, it is possible to reliably avoid, for example, unintentional cladding tube or membrane damage, for example when a liquid concrete layer (or other wall construction material) is stripped off with a power trowel or scraping tool during wall construction.

The modular system can be designed, in particular, for producing and sealing a line feedthrough against smoke and/or fire and/or other media such as heat and water, which otherwise could, for example in the event of fire or other accident situations, pass from room to room through the line feedthrough. This can be achieved by individual features of the modular system, which are described herein, in combination with a suitable material selection and/or with further fire safety measures and elements.

According to a further aspect, a method for producing and sealing a line feedthrough using a modular system presented herein is provided. The method can comprise, for example, the following steps:
selecting from the modular system one or more of said cladding tubes in the number of lines to be laid and with cladding tube diameters which depend on the respective line diameters;
selecting from the modular system one or more mounting plates, the cut-outs in which are designed for the selected cladding tubes;
optionally connecting the selected mounting plates to one another to form one (or two identical) composite mounting plate(s) having a mounting plate surface assembled cumulatively from the interconnected mounting plates;
attaching the selected mounting plates to a wall construction structure, in particular formwork, which is provided for constructing a wall (in the most general sense, i.e., the wall can be, in particular, a side wall, a ceiling or a floor of a building space) with the line feedthrough to be produced;
inserting the selected cladding tubes with their ends provided for this purpose into the cut-outs in the selected mounting plates provided for this purpose;
pouring a flowable wall construction material that is capable of hardening or solidifying, in particular concrete, into the wall construction structure and thus around the cladding tubes and into the interspaces present between the cladding tubes, and hardening or solidifying the wall construction material, as a result of which a wall with line feedthroughs concreted therein in the form of the individual cladding tubes is formed; and
inserting a single line to be laid into each cladding tube provided for this purpose, wherein the at least one sealing membrane of the cladding tube is perforated by the line, so that the line is subsequently enclosed in a sealing manner by the perforated sealing membrane from all sides without further intervention.

In particular, pairwise identical mounting plates can be selected for assembly, and the cladding tubes can be fastened at their two ends to the associated cut-outs in the pairwise identical mounting plates before the wall construction material is poured into the wall construction structure. In particular, a particularly stable assembly of each two identical mounting plate arrangements and cladding tubes fixed in between can thereby be produced.

In a specific method variant, the mounting plates are removed after the construction of the wall, and the line feedthrough concreted therein is removed from at least one of the two ends of the cladding tubes concreted in the wall. As already mentioned, however, this is not mandatory, i.e., the mounting plates can also remain in the wall after it has been completed to further stabilize the cladding tubes in addition to the concrete, etc.

According to a further aspect, a line feedthrough is provided in a wall which has been produced by a method provided herein. If the line feedthrough has a plurality of cladding tubes, the individual cladding tubes are each completely separated from one another by interspaces, which are filled by the solidified wall construction material such as concrete, etc. and/or optionally by different fill or fire protection material.

The effectiveness of the modular system presented herein and of the corresponding method for producing and sealing cable feedthroughs was investigated in tests and compared with a conventional fire-resistant cable box of the type mentioned at the beginning, which, when used as intended, can accommodate a total of approximately 20-30 cables with cable diameters of approximately 10-20 mm. The comparative tests have shown that, in case of a line feedthrough based on the single cable principle using the modular system presented herein, significantly less intumescent material is required to achieve the same performance with regard to fire safety requirements:

While approximately 100 g of intumescent material are required for conventional fire-resistant cable boxes, only approximately 2 g of intumescent material are required for the fire-proof sealing of a single cable with an outer diameter of, for example, 10 mm in the case of the line feedthrough according to the present invention. Thus, where approximately 100 g are used for 30 cables in conventional fire-resistant cable boxes, only 30×2 g=60 g of intumescent material are used for the same number of cables in the present solution. As a result, approximately 40% of intumescent material can thus be saved while offering the same fire resistance duration. In addition, a better tightness of the cable feedthrough according to the invention in comparison with any available cable feedthrough in group arrangement could be determined in the comparative tests.

These advantages are primarily based on the separation principle underlying the proposed implementation concept on the basis of the modular system. Each cladding tube is surrounded by concrete once the latter has been poured in. As a result, the cladding tube (as some kind of single feedthrough sleeve) can be better cooled by the surrounding cool concrete than a cable bundle in a fire-resistant cable box according to the prior art, which has only little contact with the surrounding cool concrete. Another important advantage arising from the concept presented herein is that, for example, in the case of ceiling feedthroughs, a tightness of nearly 100% can be achieved. Accordingly, a chimney effect with continuous heat transfer through the cable feedthrough as known from conventional arrangements can be prevented by the modular system and its sealing concept presented herein.

The cable remains cool even longer in each cladding tube in the same test conditions, and the sealing elements on the upper sides or ends of each cladding tube are also exposed to less high temperatures. When selecting the materials for the sealing elements, and thus for the respective sealing membrane, good temperature resistance is therefore significantly less critical than in conventional systems.

This in turn enables further, better production possibilities, for example two-component injection molding (2K injection molding) for the cladding tubes. In the production of the cladding tubes of the modular system, different materials can thus be used for the cladding tubes as such and for the sealing elements thereof, which are brought together in one manufacturing step:
hard, robust, impact-resistant plastic for the cladding tube to achieve a robust line feedthrough which can withstand mechanical loads; and
soft, elastically expandable plastic for the sealing elements, and thus for the sealing membranes, in order to achieve the best possible sealing function.

On the other hand, better approvals with regard to fire protection can also be achieved with the modular concept on the basis of the separation principle as presented herein:
a greater fire resistance duration, such as EI 180, compared to the fire resistance duration EI 90 that can be achieved with conventional systems; or
significantly less intumescent material is required with normal fire resistance duration of e.g. EI 90; or
Smaller wall or ceiling thicknesses with the same fire resistance duration are also possible,

In particular, the following positive properties and effects can be ensured with the concept presented herein:
a pouring solution or pouring device; fire protection is first mounted, no risk of improper application due to too small a distance of the lines, no risk of improper application by using too little fire protection material, simple inspection;
customizable to each wall or ceiling feedthrough and number of lines;
   can be planned in advance (BIM);
   very good smoke gas tightness due to individual line guidance;
   longer fire resistance duration;
   lower material use for the intumescent material;
   lower partition thickness.

### BRIEF DESCRIPTION OF THE FIGURES

The above aspects, embodiments and specific configurations of the invention are explained in more detail below with reference to the exemplary embodiments shown in the drawings. The drawings are schematic. Said drawings may be, but do not have to be, understood as true to scale. In the drawings:

FIG. 1 shows a longitudinal section of a cladding tube as part of a modular system according to one embodiment of the invention;

FIG. 2 shows a plan view of a mounting plate as part of a modular system according to one embodiment of the invention;

FIG. 3 shows a perspective view of further cladding tubes of the modular system according to one embodiment of the invention;

FIG. 4 shows a plan view of two identical mounting plates of the modular system according to one embodiment of the invention that are attached to one another;

FIG. 5 shows a plan view of five partly different mounting plates of the modular system according to one embodiment of the invention that are attached to one another;

FIG. 6 shows a longitudinal section of a further example of a cladding tube of the modular system according to one embodiment of the invention;

FIG. 7 shows a longitudinal section of a further example of a cladding tube of the modular system according to one embodiment of the invention;

FIG. 8 shows a perspective view of an assembly which, in one embodiment of the method according to the invention, can be present in the formwork before the concrete is poured in;

FIG. 9 shows a longitudinal section of an example of a line feedthrough concreted in a wall according to one embodiment of the invention before the insertion of lines;

FIG. 10 shows a longitudinal section of the line feedthrough of FIG. 9 after insertion of one line each into two of three passage channels;

### DETAILED DESCRIPTION OF THE INVENTION

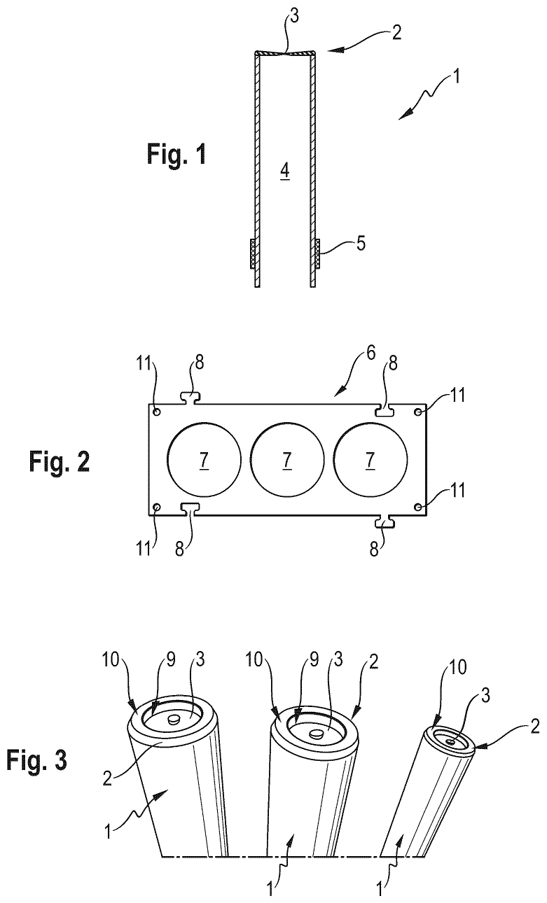

All of the various embodiments, variants and specific design features of the modular system, the associated method and the line feedthroughs produced therewith according to the above aspects of the invention, as mentioned above in the description and in the subsequent claims, can be implemented in the examples shown in FIG. 1 to 10. They are therefore not all repeated again below. The same applies mutatis mutandis to the definitions of terms and effects already specified above in relation to individual features which are shown in FIG. 1-10.

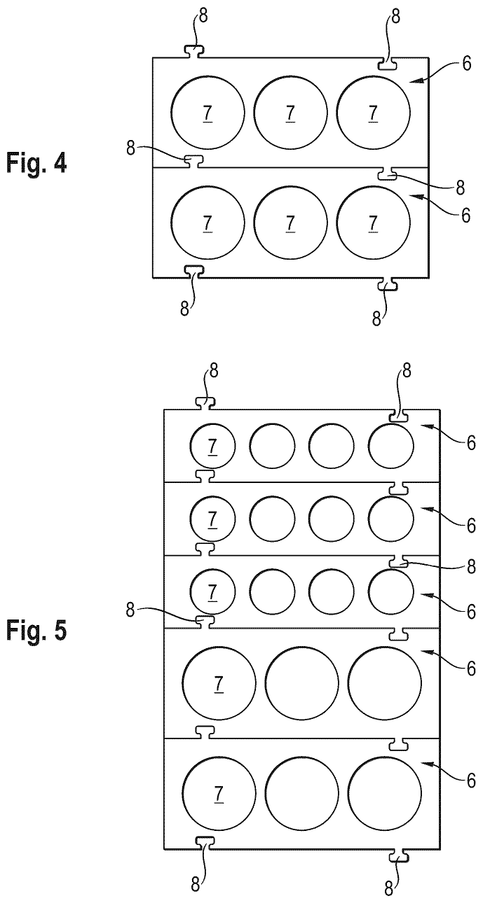

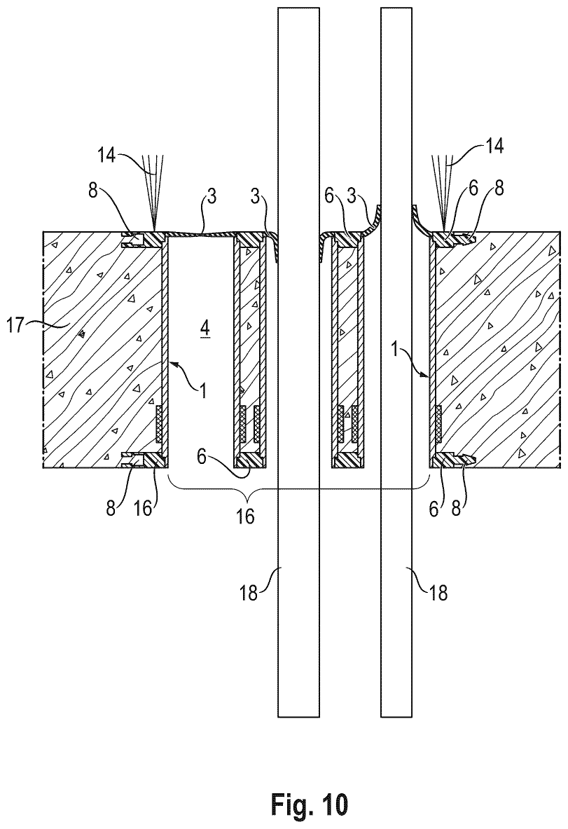

FIG. 1 shows a longitudinal section of an example of a single cladding tube 1 as part of a modular system (also referred to as kit for short) according to the first aspect of the invention. The kit can comprise a plurality of such and differently designed cladding tubes 1 with different diameter sizes (see FIG. 3). In this example, the cladding tube 1 has, at one of its two ends, a sealing element 2 with a sealing membrane 3 to be pierced by a line (only shown in FIG. 10), for example made of soft PVC, rubber etc. The sealing membrane 3 closes the passage channel 4 formed by the cladding tube 1, sealing it thereby. Furthermore, an intumescent element 5 in the form of a circumferential intumescent fire-protection wrap is provided on the outside at another end of the cladding tube 1 in this example.

FIG. 2 shows, in a plan view, an example of a rectangular mounting plate 6 made of plastic or metal, etc., which is also part of a modular system according to the first aspect of the invention. In this example, the mounting plate 6 has three identical circular cut-outs 7, each of which is designed for receiving and at least temporarily fixing a cladding tube 1, for example from FIG. 1, with a cross section and outer diameter corresponding to the cut-out 7. The kit can comprise a plurality of identically and/or differently designed mounting plates 6 with cut-outs 7 in the same or different number, size and/or arrangement, which can be connected to one another in particular to form mounting plates that are assembled in a modular manner (see FIG. 4-5).

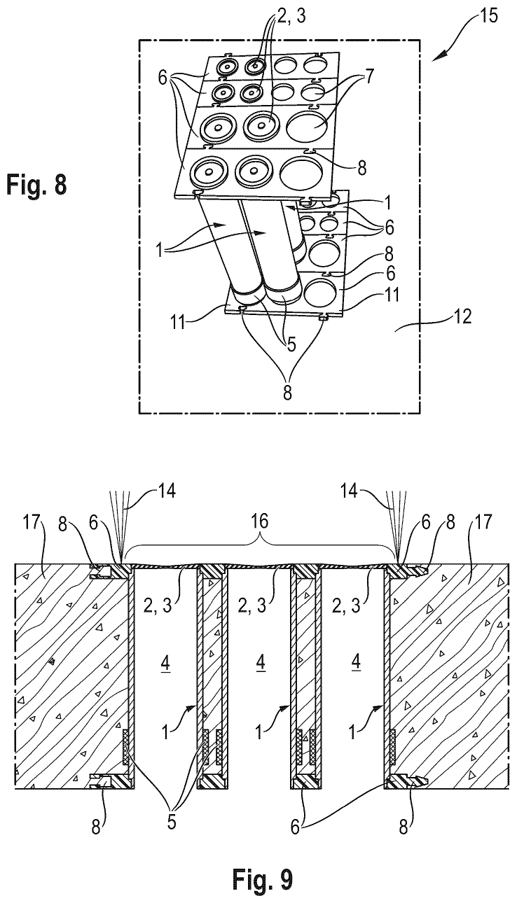

In this example, the mounting plate 6 has, on each of its two long edges, two connecting elements 8 formed complementary to one another, which are also formed and arranged in each other mounting plate 6 of the kit in the same way (see FIGS. 4 and 5), so that connecting elements 8 of two mounting plates 6 are to be brought into positive engagement with one another for fastening to one another, as shown in FIGS. 4 and 5. Furthermore, the mounting plate 6 has, in each of its corners, an optional fastening element 11 for at least temporary fastening on wall construction formwork, for example concrete formwork 12 of FIG. 8. Here, each fastening element 11 is designed as a through-hole for receiving a connecting body such as a nail, a screw or a bolt for fastening the mounting plate 6 to the concrete formwork 12 (see FIG. 8).

FIG. 3 shows, in a perspective view, purely by way of example, three or more cladding tubes 1 of the kit according to one embodiment of the invention with partially identical and partially different diameters. In the case of the two identically formed thicker cladding tubes 1, the sealing membrane 3 is arranged in its non-perforated state in each case with a predetermined axial membrane offset 9 away from the associated end face 10 in the cladding tube 1. The purpose of the axial membrane offset 9 is explained further below with reference to FIG. 8.

FIG. 4 shows a plan view of an arrangement of two identical rectangular mounting plates 6 similar to FIG. 2, which were attached to one another edge to edge by means of connecting elements 8 formed in pairs in a complementary manner.

FIG. 5 shows, likewise in a plan view, a further example of a total of five rectangular mounting plates 6, connected to one another in this way, according to one embodiment of the invention, with partially identical and partially different construction sizes and arrangements of the cut-outs 7. Otherwise, the same applies here as described with respect to FIG. 4.

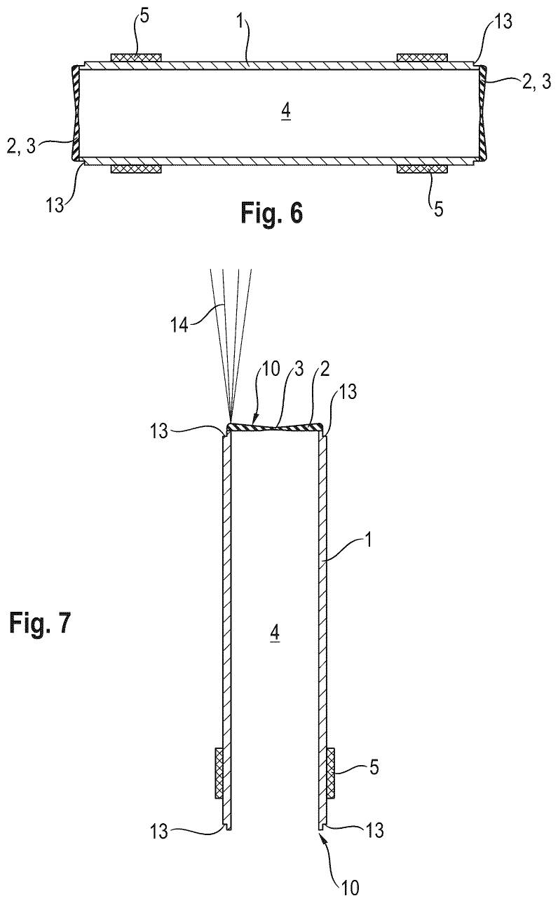

FIG. 6 shows a longitudinal section of a further example of a cladding tube 1 of the kit according to one embodiment of the invention, which kit can be used for example for a line feedthrough in a side wall of a building. It differs from the cladding tube 1 of FIG. 1 only in that, at both of its ends, it has an outer intumescent element 5 in the form of a circumferential intumescent fire-protection wrap (also referred to as an intumescent strip) and a sealing element 2 with a sealing membrane 3, which seals the passage channel, and by circumferential shoulders 13, which are described below with reference to FIG. 7.

FIG. 7 shows a longitudinal section of a further example of a cladding tube 1 of the kit according to one embodiment of the invention. On the one hand, it differs from the cladding tube 1 of FIG. 1 in that it has a circumferential shoulder 13 at both of its ends for improved connection to the mounting plates 6 of the kit. In this example, the shoulder 13 is formed by a depression extending from the respective end face 10 of the cladding tube 1 to the shoulder 13 and serves to limit the depth when the cladding tube 1 is mounted on a mounting plate 6. In this case, the intumescent element 5 is arranged (here at a predetermined axial undercut distance from the end face 10 and from the shoulder 13) in such a way that an undercut can be produced in the concrete during embedding.

Furthermore, the cladding tube 1 of FIG. 7 has a locating element 14 extending by a predetermined length axially beyond the end surface or end face 10 of the cladding tube 1, here in the form of brush-like whiskers injection-molded on the cladding tube 1. The whiskers serve to locate the line feedthrough if it can no longer be easily located from the outside when the wall is cast in. Alternatively or additionally, such locating elements 14 (brush elements) could also be attached to the mounting plate 6, as shown in FIGS. 9 and 10.

FIG. 8 shows a perspective view of an assembly 15 (also referred to as module), which can be present in a method according to the invention described further above and in the claims shortly before the wall construction material (here concrete) is poured into the concrete formwork 12. The assembly comprises two identical mounting plates, each composed of four individual mounting plates 6 each having three or four cut-outs 7 of different size, attached to one another in each case edge to edge similar to FIG. 5, between which in this example eight cladding tubes 1 are positioned and fixed in the cut-outs 7 of corresponding different size. In FIG. 8, the lower of the two composite mounting plates is provisionally attached to the formwork 12 during concreting by means of the fastening elements 11 (through-holes with nails). As can be seen from this example, not all cut-outs 7 in the assembly 15 have to be necessarily occupied by cladding tubes 1.

FIG. 9 shows a longitudinal section of an example of a concreted line feedthrough 16 in a wall 17 (here: a ceiling) produced by a method according to the second aspect of the invention before lines 18 (such as cables or pipes, see FIG. 10) are inserted. In this longitudinal section, the line feedthrough 16 has three passage channels which are each provided for one line (see FIG. 10). To produce the line feedthrough 16, for example, an assembly 15 can be used similar to that in FIG. 8 and the individual elements thereof can be used similarly to FIG. 2 to 7, so that the repeated description thereof is dispensed with. All passage channels 4 are sealed tightly by their sealing membranes 3 before the lines 18 are inserted.

FIG. 10 shows a longitudinal section of the line feedthrough 16 of FIG. 9 which is concreted in the wall 17 after the laying of lines 18 in the two of three passage channels 4, which are visible in this sectional view. As can be seen at the deflection of the respective sealing membrane 3, the “thicker” line 18 (on the left in FIG. 10) was introduced from above, while the thinner line 18, on the right, was installed from below the ceiling: during insertion of the line 18, the respective sealing membrane 3 was perforated by the line 18 and now seals it, as shown, by fitting tightly against the line 18 on all sides.

Since the wall 17 (here: ceiling) is often treated with a power trowel during concreting, the design of the line feedthrough 16 in FIGS. 9 and 10 can optionally also be designed more robustly on the upper side in order to prevent damage to the sealing membranes 3. This can be solved in two ways: the sealing membrane 3 of the cladding tube 1 can be slightly recessed therein (see FIG. 3 and the associated description) so that the latter is not damaged. Alternatively or additionally, the mounting plate 6 can be designed such that it projects slightly beyond each cladding tube 1 fixed thereto (not shown). In case of contact with the power trowel, only the mounting plate 6, but not the membrane 3, is touched.

1. A modular system for producing and sealing a line feedthrough, the modular system comprising:
a plurality of cladding tubes optionally having different cladding tube diameters, wherein each cladding tube forms an axial passage channel inside for passing through a single line and is closed by a sealing element on at least one of its two end faces, wherein the sealing element has a pierceable sealing membrane which is designed to enclose from all sides a line which is pierced through it; and
a plurality of mounting plates, optionally which are identical in pairs and/or can be connected to one another edge to edge to form an enlarged surface, wherein each mounting plate has one or more cut-outs and each cut-out is designed for receiving and at least temporarily fixing one of the plurality of cladding tubes having an outer diameter that corresponds to the one or more cut-outs;
wherein the one or more cut-outs in the respective each mounting plate are arranged and formed in relation to radial outer dimensions of the associated plurality of cladding tubes in such a way that an interspace for filling with a wall construction material remains between the plurality of cladding tubes which are fixed to directly adjacent cut-outs.

2. The modular system according to claim 1,
wherein the plurality of mounting plates can be fastened to one another in each case edge to edge and the one or more cut-outs are configured identically or differently from each mounting plate to mounting plate in the same or different number and/or arrangement in each case;
wherein the one or more cut-outs in each of the plurality of mounting plates are arranged and formed in relation to the radial outer dimensions of the associated plurality of cladding tubes in such a way that an interspace for filling with a wall construction material remains between the plurality of cladding tubes which are fixed to directly adjacent one or more cut-outs in each of two mounting plates connected to one another.

3. The modular system according to claim 2, wherein:
the plurality of mounting plates have at least one connecting element for fastening to one another; and
optionally each of the plurality of mounting plates has at least two connecting elements which are designed to be complementary to one another, and are designed and arranged in the same way in each mounting plate, so that the at least two connecting elements of two mounting plates can be brought into positive engagement with one another for fastening to one another.

4. The modular system according to claim 1, wherein:
at least some of the one or more cut-outs are formed as through-openings in the plurality of mounting plates, into which through-openings the associated plurality of cladding tubes can be at least partially inserted for fixing them to each of the plurality of mounting plates; and optionally
the respective axial passage channel remains unconcealed by each of the plurality of mounting plates.

5. The modular system according to claim 1, wherein:
at least some of the plurality of cladding tubes have a circumferential shoulder on the outside of at least at one of their two ends, which circumferential shoulder is arranged at a predetermined axial shoulder distance from the end face of the cladding tube; and
the associated one or more cut-outs in the plurality of mounting plates have an inner diameter which substantially corresponds exactly to an outer diameter of such an associated cladding tube in its axial end section beyond the circumferential shoulder, so that the cladding tube can be inserted into the one or more cut-outs up to the stop on the circumferential shoulder.

6. The modular system according to claim 1, wherein:
at least some of the plurality of cladding tubes have an intumescent element on the inside and/or on the outside which is optionally designed as a circumferential strip made of, or comprising, an intumescent material;
the intumescent element is optionally arranged on the outside at a predetermined axial undercut distance from the respective end face or, optionally, from the circumferential shoulder of the cladding tube.

7. The modular system according to claim 1, wherein:
at least in the case of some of the plurality of cladding tubes, the pierceable sealing membrane is arranged in its non-perforated state in each case with a predetermined axial membrane offset at a distance from the associated end face in the cladding tube.

8. The modular system according to claim 1, wherein;
at least one of the plurality of mounting plates has at least one fastening element for at least temporarily fastening to wall construction formwork; optionally
the at least one fastening element is designed as a through-hole for receiving a connecting body including at least one selected from the group consisting of: a nail, a screw and a bolt.

9. The modular system according to claim 1, wherein:
at least some of the plurality of cladding tubes have, at least at one of their two ends, a locating element extending axially beyond the end face of the cladding tube by a predetermined length, optionally in the form of brush-like whiskers attached to the cladding tube; and/or
at least one of the plurality of mounting plates has in an edge region of its surface at least one locating element projecting by a predetermined length from the mounting plate surface, optionally in the form of brush-like whiskers attached to the mounting plate.

10. The modular system according to claim 1, wherein:
the plurality of cladding tubes, on the one hand, and the associated one or more cut-outs in the plurality of mounting plates, on the other hand, are designed such that the respective cladding tube in its state fixed to the mounting plate does not protrude axially beyond a mounting plate surface facing away from the cladding tube; and optionally
the mounting plate surface projects by a predetermined axial protection offset beyond the end face of the cladding tube fixed thereto.

11. The modular system according to claim 1, wherein the modular system is designed for producing and sealing a line feedthrough against smoke and/or fire.

12. A method for producing and sealing a line feedthrough using the modular system according to claim 1, the method comprising:
selecting from the modular system one or more of said plurality of cladding tubes at least in the number of lines to be laid and with cladding tube diameters which depend on the respective line diameters;
selecting from the modular system one or more of the plurality of mounting plates, the one or more cut-outs in which are designed for the selected cladding tubes;
optionally connecting some of the selected plurality of mounting plates to one another to form one or two identical composite mounting plate(s) having a mounting plate surface assembled cumulatively from interconnected mounting plates;
attaching the selected plurality of mounting plates to a wall construction structure, optionally to formwork, which is provided for producing a wall with the line feedthrough to be produced;
inserting the selected plurality of cladding tubes with their ends provided for this purpose into the one or more cut-outs in the selected plurality of mounting plates provided for this purpose;
pouring a flowable wall construction material that is capable of solidifying, optionally concrete, into the wall construction structure and thus around the plurality of cladding tubes and into interspaces present between the plurality of cladding tubes, and solidifying the wall construction material, as a result of which a wall with the line feedthrough concreted therein in the form of the individual cladding tubes is formed; and
inserting a single line to be laid into each cladding tube provided for this purpose, wherein the at least one sealing membrane of the cladding tube is perforated by the line, so that the line is subsequently enclosed in a sealing manner by the perforated sealing membrane from all sides.

13. The method according to claim 12, wherein:
pairwise identical mounting plates are selected, and the cladding tubes are fixed at their two ends to the associated one or more cut-outs in the pairwise identical mounting plates before the wall construction material is poured into the wall construction structure.

14. The method according to claim 12, wherein:
the plurality of mounting plates are removed, after construction of the wall, from at least one of the two ends of the plurality of cladding tubes concreted in the wall.

15. A line feedthrough in a wall produced by the method according to claim 12, wherein:
the line feedthrough comprises a plurality of cladding tubes, the cladding tubes are each separated from one another by interspaces which are filled by solidified wall construction material.
